(19) United States
(12) Patent Application Publication
(10) Pub. No.: US 2005/0249931 A1
(43) Pub. Date: Nov. 10, 2005

(54) Nonwoven fabric-laminate and an automotive internal trim panel

(75) Inventor: Akira Utsumi, Shiga (JP)

Correspondence Address: DARBY & DARBY P.C., P. O. BOX 5257, NEW YORK, NY, 10150-5257, US

(73) Assignee: Japan Vilene Company, Ltd., Shiga (JP)

(21) Appl. No.: 11/155,953

(22) Filed: Jun. 17, 2005

Related U.S. Application Data
(62) Division of application No. 09/460,361, filed on Dec. 13, 1999.

(30) Foreign Application Priority Data
Dec. 11, 1998 (JP) 10-352639

(51) Int. Cl. B32B 5/26; B32B 7/02; B32B 27/12

(52) U.S. Cl. 428/218; 442/381; 442/387; 442/388; 442/392; 442/394; 442/335; 442/336; 442/337; 442/338; 428/376; 428/397; 428/398; 428/399

(57) ABSTRACT

A nonwoven fabrics-laminate comprising a rigid layer of an entanglement-based nonwoven fabric and a bulky layer of a bulky nonwoven fabric having an apparent density lower than that of the rigid layer; an average of a longitudinal tensile strength and a transverse tensile strength of a merely-entangled nonwoven fabric from which the entanglement-based nonwoven fabric is derived being not less than 150 N/50 mm width is disclosed. An automotive internal trim panel into which the nonwoven fabrics-laminate is shaped is also disclosed.

### BACKGROUND OF THE INVENTION

1. Field of the Invention

The present invention relates to a nonwoven fabrics-laminate, i.e., a laminate of nonwoven fabrics, and an automotive internal trim panel. The nonwoven fabrics-laminate of the present invention may be used to form the shape of the automotive internal trim panel, such as a headlining, a rear package tray, a door trim, a floor insulator, a trunk trim, or a dashboard insulator. The nonwoven fabrics-laminate of the present invention may be used as a starting material for the automotive internal trim panel.

2. Description of the Related Art

As a starting material used to form the shape of an automotive internal trim panel, hitherto, a plastics plate, a plastics foam, a resin felt of a thermosetting resin, a corrugated board, a hardboard or a paperboard prepared by adding wood flour or waste-paper to a thermosetting resin or the like have been used. However, the plastics plate is heavy and stiff, and does not have sound absorption. The plastics foam also does not have sound absorption, is easily cracked, and cannot be used in a deep drawing forming. The resin felt is heavy and requires a long heating time when forming a substrate. Further, when the resin felt is used, a surface material may be damaged in a one-step shaping process, and therefore, a two-step shaping process must be carried out wherein a substrate is formed, then a surface material is laid thereon, and a shaping operation is conducted. Namely, the shaping workability thereof is poor. The resin felt has a poor rigidity, and a substrate prepared therefrom has a low mechanical strength. The corrugated board, the hardboard or the paperboard cannot be used in a deep drawing forming, but require a two-step shaping process. Further, the hardboard is heavy.

Various techniques have been proposed to resolve the above defects. For example, Japanese Unexamined Patent Publication (Kokai) No. 7-3599 discloses an acoustic material having a high rigidity and containing-high-softening-point fibers with a particular fineness, and low-softening-point fibers with a particular fineness, in a particular ratio. Further, Japanese Unexamined Patent Publication (Kokai) No. 8-108810 discloses an automotive internal trim panel containing high-softening-point fibers with a particular fineness and low-softening-point fibers with a particular fineness, in a particular ratio, as well as particular low-softening-point fibers. Still further, Japanese Unexamined Patent Publication (Kokai) No. 8-156161 discloses a nonwoven fabrics-laminate containing (1) a fusible layer of a low-density nonwoven fabric, (2) rigid layers made of a high-density nonwoven fabric and located on both sides of the fusible layer, and (3) a surface layer located as an outermost layer.

The techniques disclosed in the above Japanese Patent publications provide some advantageous effects in sound absorption, rigidity, weight-lightening property or the like, but such effects are insufficient. Particularly, when only recyclable polyester resins are used to prepare an automotive internal trim panel, taking into account protection of the environment, a light and rigid material has not been developed. That is, an increase of rigidity requires an increase in weight to some extent, whereas weight-lightening results in a loss of rigidity. The materials disclosed in the above Japanese Patent publications could not be used in practice.

### SUMMARY OF THE INVENTION

Accordingly, the object of the present invention is to remedy the above disadvantages of the conventional materials, and to provide a light and rigid laminate of nonwoven fabrics, i.e., a nonwoven fabrics-laminate, and an automotive internal trim panel which is formed by the nonwoven fabrics-laminate.

Other objects and advantages of the present invention will be apparent from the following description.

In accordance with the present invention, there is provided a nonwoven fabrics-laminate comprising (1) a rigid layer of an entanglement-based nonwoven fabric and (2) a bulky layer of a bulky nonwoven fabric having an apparent density lower than that of the rigid layer; an average of a longitudinal tensile strength and a transverse tensile strength of a merely-entangled nonwoven fabric from which the entanglement-based nonwoven fabric is derived being not less than 150 N/50 mm width.

In accordance with the present invention, there is also provided an automotive internal trim panel into which the nonwoven fabrics-laminate is shaped.

### DESCRIPTION OF THE PREFERRED EMBODIMENTS

The nonwoven fabrics-laminate of the present invention contains one or more rigid layers of the entanglement-based nonwoven fabric. An average of a longitudinal tensile strength and a transverse tensile strength of a merely-entangled nonwoven fabric from which the entanglement-based nonwoven fabric is derived is 150 N/50 mm width or more. The term “merely-entangled nonwoven fabric” as used herein means a nonwoven fabric prepared by entangling a fiber web, the shape of which is maintained only by the entanglement of the constituent fibers. The term “entanglement-based nonwoven fabric” as used herein means a nonwoven fabric prepared by subjecting the merely-entangled nonwoven fabric to one or more further treatments for preparing a nonwoven fabric, such as a fusing treatment or an adhering treatment with a binder. The “entanglement-based nonwoven fabric” includes the merely-entangled nonwoven fabric. The average of a longitudinal tensile strength and a transverse tensile strength will be sometimes hereinafter referred to as an “average tensile strength”. An average tensile strength of an entanglement-based nonwoven fabric prepared by fusing the merely-entangled nonwoven fabric and/or adhering the merely-entangled nonwoven fabric with a binder becomes higher than that of the starting material, i.e., the merely-entangled nonwoven fabric.

The average tensile strength of 150 N/50 mm width or more in the merely-entangled nonwoven fabric means that a degree of the entanglement of the constituent fibers in the merely-entangled nonwoven fabric is high and that the merely-entangled nonwoven fabric has a high rigidity. Further, an entanglement-based nonwoven fabric prepared by subjecting the merely-entangled nonwoven fabric as a starting material to one or more further treatments for preparing a nonwoven fabric, such as a fusing treatment or an adhering treatment with a binder, has an average tensile strength higher than that of the starting material. The nonwoven fabrics-laminate of the present invention contains the rigid layer of the entanglement-based nonwoven fabric having such a high average tensile strength, and thus has a form stability. The nonwoven fabrics-laminate of the present invention can ensure a rigidity of the whole laminate owing to the inclusion of the rigid layer of the entanglement-based nonwoven fabric, and contains the laminated bulky layer having an apparent density lower than that of the rigid layer to thereby realize a weight-lightening in a whole laminate. Therefore, the nonwoven fabrics-laminate of the present invention is not only rigid but also light. The rigid and light nonwoven fabrics-laminate can be shaped into the automotive internal trim panel of the present invention, and thus, the resulting automotive internal trim panel is not only rigid but also light.

The average tensile strength of the merely-entangled nonwoven fabric is preferably 160 N/50 mm width or more, more preferably 170 N/50 mm-width or more, still further preferably 180 N/50 mm width or more, most preferably 190 N/50 mm width or more. There is no particular upper limit to the average tensile strength, but approximately 500 N/50 mm width is most preferable.

The term “tensile strength” as used herein means a force necessary to break the entanglement-based nonwoven fabric (such as the merely-entangled nonwoven fabric) when the entanglement-based nonwoven fabric is cut into a sample with a width of 50 mm, both edges of the entanglement-based nonwoven fabric sample are fixed to chucks (chuck-to-chuck distance=100 mm) of a tensile tester (TENSILON UCT-500; ORIENTEC, Co.), and pulled at a rate of 200 mm/min. Each of the “longitudinal tensile strength” and the “transverse tensile strength” is an average value, and the average value is calculated from at least five values measured. The “longitudinal” direction of the merely-entangled nonwoven fabric means a direction of travel of a fiber web upon a preparation of the merely-entangled nonwoven fabric, and the “transverse” direction of the merely-entangled nonwoven fabric means a direction crossing the “longitudinal” direction at right angles.

The average tensile strength of-the merely-entangled nonwoven fabric is a value pertaining to a nonwoven fabric the shape of which is maintained only by the entanglement, and thus is an index showing only a degree of entanglement. That is, because any bindings of constituent fibers resulting from any treatments other than an entanglement, such as bindings obtained by fusing constituent fibers or adhering constituent fibers with a binder, are not implicated in the merely-entangled nonwoven fabric. Namely, the tensile strength of the merely-entangled nonwoven fabric is an index showing only the degree of entanglement.

The merely-entangled nonwoven fabric having such a high average tensile strength of 150 N/50 mm width or more is not easily prepared by a needle-punching method, but can be produced by a fluid jet entangling method, such as a hydro-entangling method, using a high energy fluid jet. The term high energy fluid jet means a stream having an E value of 6 or more. The E value is calculated by an equation (1):
E=R×P² (1)
wherein R denotes a diameter (mm) of a nozzle, and P denotes an inner pressure (MPa) in the nozzle. The E value of the high energy fluid jet is preferably 8 or more, more preferably 10 or more, most preferably 12 or more. The merely-entangled nonwoven fabric having such a high average tensile strength can be produced by treating a fiber web at least once with the high energy fluid jet.

The E value calculated by the equation (1) has been adopted as an index showing a kinetic energy of the fluid jet, taking into account that a kinetic energy is proportional to a mass and power of two of speed, because a mass of the fluid becomes larger as a diameter of a nozzle becomes larger, and a speed of the fluid becomes faster as an inner pressure of the nozzle becomes higher.

The high energy fluid jet can be produced by ejecting a fluid from a nozzle plate containing one or more lines of nozzles having a diameter of 0.05 to 0.3 mm and a pitch of 0.2 to 3 mm under a pressure of 5 to 30 MPa. By applying the high energy fluid jet to not only a front side but also a rear side, i.e., both sides of a fiber web, the degree of entanglement can be enhanced, and the average tensile strength and the rigidity can be increased. Further, by applying the high energy fluid jet twice or more, the degree of entanglement can be enhanced, and the average tensile strength and the rigidity can be increased. When the high energy fluid jet is applied twice or more, a total value of E values of the respective fluid jets is preferably 12 or more, more preferably 16 or more, most preferably 20 or more. When a fiber web is entangled on a support, it is preferable to use a perforated support containing pores having a diameter of 0.295 mm or less, to thereby uniformly entangle a whole fiber web.

If the rigidity in a longitudinal direction is not balanced with that in a transverse direction in a sheet of the entanglement-based nonwoven fabric (such as the merely-entangled nonwoven fabric), plural sheets of fiber webs having different fiber-orientating directions are stacked, and the high energy fluid jet is applied to the stacked sheets, whereby the rigidities in the longitudinal and transverse directions of the rigid layer can be appropriately balanced with each other. For example, a first fiber web wherein fibers are unidirectionally orientated is laid on a second fiber web wherein fibers are unidirectionally orientated, in such a way that an angle of the orientating direction in the first fiber web to that in the second fiber web becomes 10° or more. Then, the high energy fluid jet is applied to the stacked sheets, whereby the rigidities in longitudinal and transverse directions of the rigid layer can be appropriately balanced with each other.

In a preferable embodiment of the nonwoven fabrics-laminate of the present invention, the rigid layer contains thermally-fusible fibers, and the entanglement-based nonwoven fabric is fused with the thermally-fusible fibers. The entanglement-based nonwoven fabric in which thermally-fusible fibers are contained as the constituent fibers and the thermally-fusible fibers are fused is hereinafter referred to as the “fused-entangled nonwoven fabric”. The fusion of the thermally-fusible fibers can further enhance the rigidity of the rigid layer. Particularly, the merely-entangled nonwoven fabric used in the present invention is highly entangled, and can provide many fusing points of the thermally-fusible fibers. Therefore, the rigidity of the fused-entangled nonwoven fabric becomes very high.

The thermally-fusible fiber may be a fully or partially thermally-fusible fiber. It is preferable to use the partially thermally-fusible fiber, which can maintain fiber shapes by non-fusible resins, and thus suppress any reduction of rigidity. The partially thermally-fusible fiber which may be preferably used comprises a fusible component and a non-fusible component. The non-fusible component does not melt at a melting point of the fusible component. The fusible component is preferably made of a resin having a melting point lower than that of the non-fusible component, preferably by 10° C. or more, more preferably by 20° C. or more. Further, the fusible component in the thermally-fusible fiber is preferably made of a resin having a melting point lower than melting points of other constituent fibers in the fused-entangled nonwoven fabric (or the rigid layer), preferably by 10° C. or more, more preferably by 20° C. or more. A cross-sectional shape of the partially thermally-fusible fiber which may be preferably used is, for example, a sheath-core type, an eccentric type, an islands-in-sea type, a laminated type, an orange type, or a multiple bimetal type. Of these partially thermally-fusible fibers, the sheath-core type, eccentric type or islands-in-sea type is preferable, because a whole surface of the fiber can be covered with the fusible component, and an excellent fusibility can be provided.

As a resin constituting the thermally-fusible fiber, there may be mentioned, for example, a polyamide-based resin, a polyester-based resin, a polyolefin-based resin, such as a polyethylene-based, polypropylene-based or polymethylpentene-based resin, which may be used singly or in combination thereof. Of these resins, it is preferable to use thermally-fusible fibers made of substantially only polyester-based resin, from the viewpoint of recyclability. Preferably, the fusible component of the thermally-fusible fiber has a high crystallizability, because the fusible component with a low crystallizability has a tendency to lower the fusibility at an elevated temperature. A heat of fusion of the fusible component is preferably 8 J/g or more, more preferably 12 J/g or more.

The term “melting point” as used herein means a temperature giving a maximum value in a melting-endotherm curve obtained by raising a temperature at a rate of 10° C./minute from room temperature in a differential scanning calorimeter. When two or more maximum values are obtained in the melting-endotherm curve, the term “melting point” as used herein means the highest value. The term “heat of fusion” as used herein means a value obtained from a melting-endotherm curve obtained by raising a temperature at a rate of 10° C./minute from room temperature in a differential scanning calorimeter.

A fineness of the thermally-fusible fiber is not particularly limited, but a fine thermally-fusible fiber capable of providing many fusing points of fibers is preferable. Specifically, the fineness is preferably about 1 to 30 denier, more preferably about 1 to 20 denier. The thermally-fusible fibers are contained in the fused-entangled nonwoven fabric at an amount of preferably about 10 to 90 mass %, more preferably about 20 to 70 mass %.

The fusible components of the thermally-fusible fibers may be fused by a fusing treatment. The fusing treatment may be conducted after the formation of the merely-entangled nonwoven fabric but before the lamination of the nonwoven fabrics, or after the lamination of the merely-entangled nonwoven fabric (rigid layer) and the bulky nonwoven fabric (bulky layer).

The fusing treatment may be carried out without applying pressure, with heat and pressure applied at the same time, or with heat and thereafter application of a pressure. When the fusing treatment is carried out after forming the merely-entangled nonwoven fabric but before laminating the nonwoven fabrics, it is preferable to heat and press the nonwoven fabric at the same time, or to heat and then press the nonwoven fabric, to thereby enhance the rigidity. When the fusing treatment is carried out after laminating the merely-entangled nonwoven fabric with the bulky layer, it is important not to lower bulking power. Therefore, it is preferable to heat the laminate without applying a pressure, or to heat and press the laminate at the same time or to heat and then press the laminate under a low pressure which allows a subsequent adjustment of the thickness after the treatment.

When the heat and pressure are applied at the same time in the fusing treatment of the fusible components, it is preferable to apply a heat ranging from a softening point to a melting point of the fusible component. When the heat is applied without a pressure or the pressure is applied after heating, it is preferable to apply a heat ranging from a softening point of the fusible component to a temperature higher than a melting point of the fusible component by about 20° C. The pressure applied is preferably a linear pressure of 5 to 30 N/cm.

The entanglement-based nonwoven fabric, such as the merely-entangled nonwoven fabric or the fused-entangled nonwoven fabric, for the rigid layer may contain profile fibers and/or hollow fibers. Use of the profile fibers can bring about a higher rigidity, and use of the hollow fibers can lighten the nonwoven fabric. The term profile fiber means a fiber having a non-circular cross-section. The cross-section of the profile fiber is, for example, an ellipse, an oval, a T-letter shape, a Y-letter shape, a +-mark shape, or a polygon. The term hollow fiber means a fiber containing air spaces, openings or voids in the fiber. The hollow fiber preferably contains one or more continuous air spaces, openings or voids in a lengthwise direction of the fiber. Air spaces, openings or voids are not necessary located at the center of the cross-section of the hollow fiber. Further, the hollow fiber may contain separated plural air spaces, openings or voids. The cross-section of the air spaces openings or voids is not necessary a circle, but may be a non-circle, such as an ellipse, an oval, a T-letter shape, a Y-letter shape, a +-mark shape, or a polygon.

As a resin constituting the profile or hollow fiber, there may be mentioned, for example, a polyamide-based resin, a polyester-based resin, a polyolefin-based resin, such as a polyethylene-based, polypropylene-based or polymethylpentene-based resin, which may be used singly or in combination thereof. When the profile or hollow fiber contains a combination of the resins, the cross-sectional shape is, for example, a sheath-core type, an eccentric type, an islands-in-sea type, a laminated-type, an orange type, or a multiple bimetal type. Of these resins, it is preferable to use profile or hollow fibers made of substantially only a polyester-based resin, from the viewpoint of recyclability. The profile or hollow fiber may be crimpable or dividable into fine fibers. A fineness of the profile or hollow fiber is not particularly limited, but is preferably about 1 to 90 denier, more preferably about 1 to 60 denier.

The entanglement-based nonwoven fabric, such as the merely-entangled nonwoven fabric or the fused-entangled nonwoven fabric, for the rigid layer may contain structural fibers which have a substantially circular cross-sectional shape and do not contain air spaces, openings or voids in the cross-section. The structural fiber may be, for example, an inorganic fiber, such as a glass or carbon fiber, a natural fiber, such as silk, wool, cotton, or jute, a regenerated fiber, such as a rayon fiber, a semisynthetic fiber, such as an acetate fiber, a synthetic fiber, such as a polyamide-base fiber, a polyvinyl alcohol fiber, an acrylic fiber, a polyester-based fiber, a polyvinyl chloride fiber, a polyvinylidene chloride fiber, a polyurethane fiber, a polyethylene fiber, a polypropylene fiber, a polymethylpentene fiber, or an aromatic polyamide fiber, or a conjugate fiber, such as a crimpable or dividable fiber, comprising two or more resin components. Of these fibers, it is preferable to use the structural fibers made of substantially only a polyester-based resin, from the viewpoint of recyclability. A fineness of the structural fiber is not particularly limited, but is preferably about 1 to 90 denier, more preferably about 1 to 60 denier.

An area density of the entanglement-based nonwoven fabric, such as the merely-entangled nonwoven fabric or the fused-entangled nonwoven fabric, for the rigid layer is preferably about 40 to 400 g/cm², more preferably about 50 to 300 g/cm², to ensure the required rigidity and weight-lightening. A thickness of the rigid layer may be about 0.3 to 3 mm, but is preferably about 0.5 to 2 mm, more preferably about 0.6 to 2 mm, most preferably about 0.8 to 2 mm. When the thickness of the rigid layer is 0.8 mm or more, nonwoven fabrics-laminate having an excellent rigidity may be produced. The constituent fibers of the entanglement-based nonwoven fabric, such as the merely-entangled nonwoven fabric or the fused-entangled nonwoven fabric, for the rigid layer are preferably short fibers having a length of about 20 to 160 mm, as these have a high degree of freedom, and thus show an excellent formability.

An apparent density of the rigid layer is preferably about 0.08 g/cm³ or more, more preferably about 0.09 g/cm³ or more. If the area density of the rigid layer is low, and the apparent density of the rigid layer is not less than 0.15 g/cm³, the rigid layer becomes too thin to maintain the required rigidity. Therefore, the apparent density of the rigid layer is preferably less than 0.15 g/cm³, more preferably 0.14 g/cm³ or less, most preferably 0.13 g/cm³ or less.

The nonwoven fabrics-laminate of the present invention comprises one or more laminated rigid layers and one or more laminated bulky layers of a bulky nonwoven fabric having an apparent density lower than that of the rigid layer. The bulky layer provides the weight-lightening. The apparent density of the rigid layer is about 0.08 g/cm³ or more as above, an apparent density of the bulky layer is less than about 0.08 g/cm³, more preferably about 0.02 to 0.06 g/cm³. The term “apparent density” as used herein means a value obtained by dividing an area density of a nonwoven fabric, such as the entanglement-based nonwoven fabric or the bulky nonwoven fabric, by a thickness of the nonwoven fabric. The thickness used in this case is a thickness measured when a load of 20 g/cm² is applied thereto.

A difference between the apparent density of the rigid layer and the apparent density of the bulky layer is preferably 0.14 g/cm³ or less, more preferably 0.12 g/cm³ or less, most preferably 0.10 g/cm³ or less. When the difference in the apparent densities is smaller, a difference in the shrinkage between the rigid layer and the bulky layer becomes small, and thus, it becomes difficult to peel, or separate, the rigid layer from the bulky layer. Therefore, the nonwoven fabrics-laminate having an excellent rigidity and an excellent formability can be prepared.

The bulky nonwoven fabric may be prepared, for example, by a needle-punching method, a fibers-bonding method wherein thermally-fusible fibers are fused, a binder-bonding method wherein a fiber web is bonded with a binder, such as an emulsion or latex binder, a method of simply web making fibers, such as an air-laid method or a carding method.

In a preferable embodiment of the nonwoven fabrics-laminate of the present invention, the bulky layer contains thermally-fusible fibers as in the rigid layer, and the bulky layer is fused with the thermally-fusible fibers. The fusion of the thermally-fusible fibers can further enhance the form stability. The thermally-fusible fiber may be a fiber containing a fusible component made of a resin having a melting point lower than that of the other non-fusible constituent fibers in the bulky layer, by 10° C. or more, more preferably 20° C. or more. As the thermally-fusible fiber, a partially thermally-fusible fiber containing a resin component having a melting point higher than that of the fusible constituent, by 10° C. or more, more preferably 20° C. or more, and has a sheath-core, eccentric, islands-in-sea, laminated, orange, or multiple bimetal type cross-sectional shape may be used. Of these partially thermally-fusible fibers, the sheath-core type, eccentric type or islands-in-sea type is preferable.

As a resin constituting the thermally-fusible fiber, there may be mentioned, for example, a polyamide-based resin, a polyester-based resin, a polyolefin-based resin, such as a polyethylene-based, polypropylene-based or polymethylpentene-based resin, which may be used singly or in combination thereof. Of these resins, it is preferable to use thermally-fusible fibers made of substantially only polyester-based resin, from the viewpoint of recyclability. A heat of fusion of the fusible component in the thermally-fusible fiber is preferably 8 J/g or more, more preferably 12 J/g or more. A fineness of the thermally-fusible fiber is preferably about 1 to 30 denier, more preferably about 1 to 20 denier. The thermally-fusible fibers are contained in the bulky nonwoven fabric in an amount of, preferably 5 to 80 mass %, more preferably 10 to 60 mass %, to maintain bulking power.

When the fusible component in the thermally-fusible fiber constituting the bulky nonwoven fabric, i.e., the bulky layer, is fused, a fusing treatment is preferably carried out without an application of a pressure or under a low pressure capable of maintaining the bulking power. In this case, the fusing treatment is preferably carried out by heating at a temperature ranging from a softening point of the fusible component to a temperature higher than the melting point of the fusible component by about 20° C. The fusing treatment may be conducted during the formation of the bulky nonwoven fabric, after the formation of the bulky nonwoven fabric but before the lamination of the nonwoven fabrics, or after the lamination of the nonwoven fabrics.

The bulky nonwoven fabric may contain, as the constituent fiber, profile fibers and/or hollow fibers as in the rigid layer. Use of the profile fibers and/or hollow fibers can enhance the rigidity, and therefore, a nonwoven fabrics-laminate having a higher rigidity can be produced, in combination with the rigidity due to the rigid layer. The profile fibers and/or the hollow fibers may be contained at an amount of 10 mass% or more in the bulky nonwoven fabric.

As a resin constituting the profile or hollow fiber, there may be mentioned, for example, a polyamide-based resin, a polyester-based resin, a polyolefin-based resin, such as a polyethylene-based, polypropylene-based or polymethylpentene-based resin, which may be used singly or in combination thereof. When the profile or hollow fiber contains a combination of the resins, the cross-sectional shape is, for example, a sheath-core-type, an eccentric type, an islands-in-sea type, a laminated type, an orange type, or a multiple bimetal type. The profile or hollow fiber may be crimpable or dividable into fine fibers. It is preferable to use profile or hollow fibers made of substantially only a polyester-based resin, from the viewpoint of recyclability. A fineness of the profile or hollow fiber is preferably about 1 to 90 denier, more preferably about 1 to 60 denier.

The bulky nonwoven fabric, i.e., the bulky layer, may preferably contain, as the constituent fiber, stereoscopically crimped fibers, to maintain the bulking power. The stereoscopically crimped fiber may be prepared by heating laminate or eccentric type conjugate fibers containing two or more resin components having different heat shrinkabilities. When the profile and/or hollow fibers are also stereoscopically crimped fibers, not only a bulking power but also a rigidity can be imparted. The stereoscopically crimped fiber may be prepared by combining two or more resins having different heat shrinkabilities, for example, from a polyamide-based resin, a polyester-based resin, a polyolefin-based resin, such as a polyethylene-based, polypropylene-based or polymethylpentene-based resin. It is preferable to use stereoscopically crimped fibers made of substantially only a polyester-based resin, from the viewpoint of recyclability. A fineness of the stereoscopically crimped fiber is preferably about 1 to 90 denier, more preferably about 1 to 60 denier.

In addition to the thermally-fusible fibers, the profile fibers, hollow fibers, and the stereoscopically crimped fibers, the bulky nonwoven fabric, i.e., the bulky layer, may contain structural fibers which have a substantially circular cross-sectional shape and do not contain air spaces, openings or voids in the cross-section, as in the rigid layer. Of these structural fibers, it is preferable to use the structural fibers made of substantially only a polyester-based resin, from the viewpoint of recyclability. A fineness of the structural fiber is preferably about 1 to 90 denier, more preferably about 1 to 60 denier.

An area density of the bulky layer of the bulky nonwoven fabric is preferably about 50 to 1000 g/cm², more preferably about 100 to 900 g/cm², to ensure the required form stability and weight-lightening. A thickness of the bulky layer may be about 2 to 50 mm, but is preferably about 3 to 30 mm. The constituent fibers of the bulky nonwoven fabric for the bulky layer are preferably short fibers having a length of about 20 to 160 mm, because they have a high degree of freedom, and thus an excellent formability.

The nonwoven fabrics-laminate of the present invention contains the rigid layer consisting essentially of the entanglement-based nonwoven fabric and the bulky layer consisting essentially of the bulky nonwoven fabric, and therefore has required rigidity, and the weight thereof is lightened. The numbers and the sequential order of the rigid layers and the bulking layers are not particularly limited. There may be mentioned, for example, a laminate wherein a rigid layer and a bulky layer are laminated, a laminate wherein a rigid layer is sandwiched between two bulky layers, a laminate wherein a bulky layer is sandwiched between two rigid layers, or a laminate wherein plural bulky layers and plural rigid layers are alternately stacked. Of these embodiments, it is preferable to use the laminate containing a bulky layer sandwiched with two rigid layers, because the laminate is light and has a high rigidity. When a surface layer as mentioned below is further laminated, an embodiment wherein a rigid layer is laminated on one side of a bulky layer and a surface layer is laminated on the other side of the bulky layer is preferable, for the same reason.

The rigidities in the longitudinal and transverse directions of the nonwoven fabrics-laminate as a whole can be appropriately balanced with each other by laminating the entanglement-based nonwoven fabric (the rigid layer) and the bulky nonwoven fabric (the bulky layer) so that the orientating direction of the constituent fibers of the former fabric becomes different from that of the constituent fibers of the latter fabric. For example, the nonwoven fabrics-laminate having properly balanced rigidities in the longitudinal and transverse directions can be prepared by laminating the entanglement-based nonwoven fabric (the rigid layer) and the bulky nonwoven fabric (the bulky layer) so that the orientating direction of the constituent fibers of the former fabric and that of the constituent fibers of the latter fabric cross at right angles. The above procedures may be applied to an embodiment wherein the surface layer is laminated in addition to one or more rigid layers and one or more bulky layers, or instead of one of the rigid layers.

It is preferable that the constituent fibers of each of the rigid layers (the entanglement-based nonwoven fabrics) and the bulky layers (the bulky nonwoven fabrics) in the nonwoven fabrics-laminate of the present invention essentially consist of polyester-based fibers, from the viewpoint of recyclability.

The nonwoven fabrics-laminate of the present invention may contain layer (i.e., one surface layer) in addition to one or more rigid layers and-one or more bulky layers. The surface layer may comprise of, for example, a natural leather, an artificial leather, a synthetic leather, a woven fabric, a knitted fabric, a nonwoven fabric (e.g., a spun-bonded nonwoven fabric), or a-film. It is preferable to use the nonwoven fabric, as it is suitable for a deep drawing process.

The nonwoven fabric which may be preferably used for the surface layer (hereinafter referred to as a “surface nonwoven fabric”) may be prepared, for example, by a spun-bonding method, a needle-punching method, a fluid jet entangling method, a fibers-bonding method wherein thermally-fusible fibers are fused, a binder-bonding method wherein a fiber web is bonded with a binder, such as an emulsion or latex binder. Of these methods, the nonwoven fabric prepared by the needle-punching method is preferable as this provides it with an excellent designing property. The needle-punching method can be carried out at a needle density of 300 to 500 needles/cm². When a greater rigidity is required in the nonwoven fabrics-laminate, a nonwoven fabric prepared by the fluid jet entangling method is preferably used as the surface layer.

It is preferable that the surface nonwoven fabric (i.e., the surface layer) contains thermally-fusible fibers as in the rigid layer, and the thermally-fusible fibers are fused therein, because the thermally-fusible fibers can further enhance the form-stability. The thermally-fusible fiber containing a resin having a melting point lower than those of the other constituent fibers in the surface nonwoven fabric by 10° C. or more, more preferably 20° C. or more, may be used. As the thermally-fusible fiber, a partially thermally-fusible fiber containing a resin component having a melting point higher than that of the fusible constituent, by 10° C. or more, more preferably 20° C. or more, and having a sheath-core, eccentric, islands-in-sea, laminated, orange, or multiple bimetal type cross-sectional shape may be used. Of these partially thermally-fusible fibers, the sheath-core type, eccentric type or islands-in-sea type is preferable.

As a resin constituting the thermally-fusible fiber, there may be mentioned, for example, a polyamide-based resin, a polyester-based resin, a polyolefin-based resin, such as a polyethylene-based, polypropylene-based or polymethylpentene-based resin, which may be used singly or in combination thereof. Of these resins, it is preferable to use thermally-fusible fibers made of substantially only a polyester-based resin, from the viewpoint of recyclability. A fusion heat of the fusible component in the thermally-fusible fiber is preferably 8 J/g or more, more preferably 12 J/g or more. A fineness of the thermally-fusible fiber is preferably about 1 to 30 denier, more preferably about 1 to 20 denier. To maintain a tactility of the surface nonwoven fabric, the thermally-fusible fibers are contained in the surface nonwoven fabric at an amount of preferably 50 mass % or less, more preferably 30 mass % or less. Further, to maintain the form-stability, the thermally-fusible fibers are contained in the surface nonwoven fabric at an amount of preferably 5 mass % or more. The surface nonwoven fabric (the surface layer) wherein the thermally-fusible fibers are contained and the thermally-fusible fibers are fused therein can enhance the rigidity. Therefore, it is possible to omit one of the plural rigid layers from the nonwoven fabrics-laminate of the present invention containing the surface layer, so long as the nonwoven fabrics-laminate contains at least one rigid layer.

When the thermally-fusible fibers are contained in the surface nonwoven fabric, i.e., the surface layer, a fusing treatment of the fusible component is preferably carried out without the application of a pressure, or under a low pressure capable of maintaining a proper tactility. In this case, it is preferable to use a heat at a temperature ranging from a softening point of the fusible component to a temperature higher than a melting point of the fusible component by about 20° C.

In addition to the thermally-fusible fibers, the surface nonwoven fabric, i.e., the surface layer, may contain other fibers as in the rigid layer. That is, the surface nonwoven fabric may contain the profile fibers, the hollow fibers and/or the structural fibers (such as the crimpable or dividable fibers) which have a substantially circular cross-sectional shape and do not contain air spaces, openings or voids in the cross-section. As the rigid or bulky layers, the constituent fibers of the surface nonwoven fabric, i.e., the surface layer, are preferably made of substantially only polyester-based resin, from the viewpoint of recyclability. A fineness of the constituent fibers of the surface nonwoven fabric is preferably about 1 to 20 denier, more preferably about 2 to 10 denier, to thus maintain a proper tactility.

The surface nonwoven fabric, i.e., the surface layer, is visible and therefore, it is preferable that the constituent fiber, for example, the thermally-fusible fiber, the profile fiber, the hollow fiber or the structural fiber (such as the crimpable or dividable fiber) which has a substantially circular cross-sectional shape and does not contain air spaces, openings or voids in the cross-section, is chromatically colored, for example, dyed or dope-dyed.

An area density of the surface nonwoven fabric, i.e., the surface layer, is preferably about 30 to 300 g/cm², more preferably about 50 to 200 g/cm², and a thickness thereof is preferably about 0.5 to 10 mm, more preferably about 1 to 5 mm. The constituent fibers of the surface nonwoven fabric, i.e., the surface layer, are preferably short fibers having a length of about 20 to 160 mm, as they have a high degree of freedom and thus An excellent formability.

One or more entanglement-based nonwoven fabrics (i.e., the rigid layers) and one or more bulky nonwoven fabrics (i.e., the bulky layers) and optionally the surface nonwoven fabric (i.e., the surface layer) may be laminated by, for example, a needle-punching method, a fluid jet entangling method, a fibers-bonding method wherein thermally-fusible fibers constituting the rigid and/or bulky layers, and optionally, the surface layer are fused, a binder-bonding method wherein a stacked fiber web is bonded with a binder, such as an emulsion or a latex binder, or a method wherein a stacked fiber web is adhered via a thermal adhesive sheet. The thermal adhesive sheet is, for example, a three-layered sheet wherein two polyolefin resin coatings are applied on both sides of a film, such as a nylon film.

In the present invention, the rigidity of the nonwoven fabrics-laminate can be enhanced by adhering one or more rigid layers and/or one or more bulky layers with an emulsion or a latex binder. As the binder, there may be mentioned, for example, a styrene-acrylic acid ester-acrylonitrile copolymer, a styrene-acrylonitrile-butadiene, or a styrene-butadiene rubber (SBR). The amount of binder used is preferably about 20 to 400 g/m², more preferably about 50 to 200 g/m² with respect to the nonwoven fabrics-laminate.

The binder may be applied by, for example, a method wherein a binder as mentioned above is sprayed and then dried, a method wherein a binder is coated and then dried, or a method wherein the laminate is immersed in a binder bath and then dried. The binder may be applied after the formation of the entanglement-based nonwoven fabric, such as the merely-entangled nonwoven fabric or the fused-entangled nonwoven fabric, but before the lamination of the nonwoven fabrics, after the formation of the bulky nonwoven fabric but before the lamination of the nonwoven fabrics, or after the lamination of the nonwoven fabrics.

A thickness of the nonwoven fabrics-laminate of the present invention is, for example, about 3 to 40 mm, preferably about 5 to 30 mm, to ensure a bulking power. The rigidity can be enhanced by the thickness per se, in addition to the function of the rigid layers, and optionally, the bulky layers and/or the surface layers.

An average tensile strength of the nonwoven fabrics-laminate of the present invention is higher than that of the rigid layer, on other words, higher than 150 N/50 mm width. An area density of the nonwoven fabrics-laminate of the present invention is preferably about 400 to 1500 g/m², more preferably about 500 to 1200 g/m².

The rigidity of the nonwoven fabrics-laminate of the present invention may be determined with respect to a falling distance (unit=mm) in a cantilevered beam sag test. The concrete procedures of the cantilevered beam sag test will be described in “Experiment for evaluation of rigidity”. The nonwoven fabrics-laminate of the present invention shows the falling distance (i.e., an amount of sag) of 17 mm or less in the cantilevered beam sag test, at a light weight, for example, of 940 g/m² or less.

Further, the rigidity of the nonwoven fabrics-laminate of the present invention may be determined with respect to a maximum load (at a point) in a bending test. The concrete procedures of the bending test will be described in “Experiments for evaluation of properties”. The nonwoven fabrics-laminate of the present invention shows the maximum load (at a point) of 5 N/25 mm width or more in the bending test.

The automotive internal trim panel of the present invention is prepared by shaping the nonwoven fabrics-laminate of the present invention into a desired form, such as a headlining, a rear package tray, a door trim, a floor insulator, a trunk trim, or a dashboard insulator. Therefore, the automotive internal trim panel of the present invention is also light and rigid. A conventional method can be used as a shaping method. For example, a method for pressing with heating by a mold pair, a method wherein the nonwoven fabrics-laminate is heated by, for example, a circulation dryer, or a heater with far infrared rays, and then pressed by a mold pair at approximately room temperature or less. The nonwoven fabrics-laminate of the present invention contains the bulky layer, and has an excellent shapability when subjected to a deep drawing process. When the constituent fibers of the rigid layer, i.e., the merely-entangled nonwoven fabric or the entanglement-based nonwoven fabric, or the bulky layer, i.e., the bulky nonwoven fabric, are short fibers, the degree of freedom of the fibers becomes higher, and even more excellent shapability can be obtained

### EXAMPLES

The present invention now will be further illustrated by, but is by no means limited to, the following Examples.

### Example 1

(1) Preparation of an Entanglement-based Nonwoven Fabric Sheet

A 50 mass % of stereoscopically crimpable, hollow polyester-based fibers (fineness=13 denier; fiber length=51 mm; cross-sectional shape=circle) which were composed of copolymeric polyester (melting point=245° C. or more) and polyethylene terephthalate so that they were laminated in the cross-section, and contained a void continuously extending in a lengthwise direction of the fiber at a center of the cross-section (cross-sectional shape of the void=circle), and a 50 mass % of sheath-core type, heat-fusible polyester-based fibers (fineness=2 denier; fiber length=51 mm) composed of a fusible sheath component of copolymeric polyester (melting point=160° C.; heat of fusion=15 J/g) and a nonfusible core component of polyethylene terephthalate (melting point=260° C.) were mixed and the fibers then carded by a carding machine to form a unidirectionally orientated fiber web.

The resulting unidirectionally orientated fiber web was mounted on a plain weave net (mesh opening=0.175 mm). A water jet (E value=13) was ejected onto the unidirectionally orientated fiber web from a nozzle plate (internal pressure=10 MPa) containing a line of nozzles having a diameter of 0.13 mm and a pitch of 0.8 mm. Thereafter, the unidirectionally orientated fiber web was reversed, and then a water jet (E value=6.4) was ejected from the same nozzle plate (internal pressure=7 MPa). Further, the unidirectionally orientated fiber web was reversed and a water jet (E value=6.4) was ejected from the same nozzle plate (internal pressure=7 MPa) to entangle the fibers and obtain a merely-entangled nonwoven fabric sheet (area density=120 g/m²; thickness=1 mm; apparent density=0.12 g/cm³). An average tensile strength of the merely-entangled nonwoven fabric sheet was 180 N/50 mm width.

(2) Preparation of a Bulky Nonwoven Fabric Sheet

After 70 mass % of the hollow polyester-based fibers used in the preparation (1) of the merely-entangled nonwoven fabric sheet and 30 mass % of the sheath-core type, heat-fusible polyester-based fibers used in the preparation (1) of the merely-entangled nonwoven fabric sheet were mixed, the fibers were carded by a carding machine to form a unidirectionally orientated bulky nonwoven fabric sheet (area density=700 g/m²; thickness=20 mm; apparent density=0.035 g/cm³).

(3) Preparation of a Nonwoven Fabrics-laminate

The unidirectionally orientated bulky nonwoven fabric sheet obtained in the above item (2), and two merely-entangled nonwoven fabric sheets obtained in the above item (1) were stacked so that the bulky nonwoven fabric sheet was sandwiched between two merely-entangled nonwoven fabric sheets, and the directions of orientated fibers of three nonwoven fabric sheets coincided with each other. Then, the stacked sheets were treated with a needle punching (needle density=75 needles/cm²) to integrate the unidirectionally orientated bulky nonwoven fabric sheet and two merely-entangled nonwoven fabric sheets. Thereafter, the integrated sheet was heated by a circulation dryer at 170° C. to fuse the sheath components in the sheath-core type, heat-fusible polyester-based fibers, and at the same time express crimps of the hollow polyester-based fibers, and obtain a nonwoven fabrics-laminate of the present invention (area density=940 g/m²; thickness=20 mm).

### Example 2

The procedure of Example 1(1) was repeated to prepare a unidirectionally orientated fiber web. The resulting unidirectionally orientated fiber web was mounted on a plain weave net (mesh opening=0.175 mm). A water jet (E value=29.3) was ejected onto the unidirectionally orientated fiber web from a nozzle plate (internal pressure=15 MPa) containing a line of nozzles having a diameter of 0.13 mm and a pitch of 0.8 mm. Thereafter, the unidirectionally orientated fiber web was reversed, and then a water jet (E value=13) was ejected from the same nozzle plate (internal pressure=10 MPa). Further, the unidirectionally orientated fiber web was reversed and a water jet (E value=13) was ejected from the same nozzle plate (internal pressure=10 MPa) to entangle the fibers and obtain a merely-entangled nonwoven fabric sheet (area density=120 g/m²; thickness=1 mm; apparent density=0.12 g/cm³). The average tensile strength of the merely-entangled nonwoven fabric sheet was 220 N/50 mm width.

The procedure disclosed in Example 1(2) was repeated to form a unidirectionally orientated bulky nonwoven fabric sheet (area density=700 g/m²; thickness=20 mm; apparent density=0.035 g/cm³).

Further, the procedure disclosed in Example 1(3) was repeated for integrating the nonwoven fabric sheets, treating with needle-punching, fusing the fusible components and expressing crimps, to obtain a nonwoven fabrics-laminate of the present invention (area density=940 g/m²; thickness=20 mm).

### Example 3

The procedure of Example 1(1) was repeated to prepare a unidirectionally orientated fiber web. The resulting unidirectionally orientated fiber web was mounted on a plain weave net (mesh opening=0.175 mm). A water jet (E value=13) was ejected onto the unidirectionally orientated fiber web from a nozzle plate (internal pressure=10 MPa) containing a line of nozzles having a diameter of 0.13 mm and a pitch of 0.8 mm. Thereafter, the unidirectionally orientated fiber web was reversed, and then a water jet (E value=29.3) was ejected from the same nozzle plate (internal pressure=15 MPa). Further, the unidirectionally orientated fiber web was reversed and a water jet (E value=13) was ejected from the same nozzle plate (internal pressure=10 MPa). Then, the unidirectionally orientated fiber web was reversed and a water jet (E value=13) was ejected from the same nozzle plate (internal pressure=10 MPa) to entangle the fibers and obtain a merely-entangled nonwoven fabric sheet (area density=120 g/m²; thickness=1 mm; apparent density=0.12 g/cm³). The average tensile strength of the merely-entangled nonwoven fabric sheet was 260 N/50 mm width.

The procedure disclosed in Example 1(2) was repeated to form a unidirectionally orientated bulky nonwoven fabric sheet (area density=700 g/m²; thickness=20 mm; apparent density=0.035 g/cm³).

Further, the procedure disclosed in Example 1(3) was repeated for integrating the nonwoven fabric sheets, treating with needle-punching, fusing the fusible components, and expressing crimps, to obtain a nonwoven fabrics-laminate of the present invention (area density=940 g/m²; thickness=20 mm).

### Comparative Example 1

The procedure of Example 1(1) was repeated to prepare a unidirectionally orientated fiber web. The resulting unidirectionally orientated fiber web was treated with a needle punching (needle density=350 needles/cm²) to entangle the fibers and obtain a merely-entangled nonwoven fabric sheet (area density 120 g/m²; thickness=2.2 mm; apparent density=0.055 g/cm³). The average tensile strength of the merely-entangled nonwoven fabric sheet was 100 N/50 mm width.

The procedure disclosed in Example 1(2) was repeated to form a unidirectionally orientated bulky nonwoven fabric sheet (area density=700 g/m²; thickness=20 mm; apparent density=0.035 g/cm³).

Further, the procedure disclosed in Example 1(3) was repeated for integrating the nonwoven fabric sheets, treating with needle-punching, fusing the fusible components and expressing crimps, to obtain a nonwoven fabrics-laminate (area density=940 g/m²; thickness=20 mm).

### Comparative Example 2

The procedure of Example 1(1) was repeated to prepare a unidirectionally orientated fiber web. The resulting unidirectionally orientated fiber web was mounted on a plain weave net (mesh opening=0.175 mm). A water jet (E value=4.7) was ejected onto the unidirectionally orientated fiber from a nozzle plate (internal pressure=6 MPa) containing a line of nozzles having a diameter of 0.13 mm and a pitch of 0.8 mm. Thereafter, the unidirectionally orientated fiber web was reversed, and then a water jet (E value=4.7) was ejected from the same nozzle plate (internal pressure=6 MPa) to entangle the fibers and obtain a merely-entangled nonwoven fabric sheet (area density=120 g/m²; thickness=1.7 mm; apparent density=0.071 g/cm³). The average tensile strength of the merely-entangled nonwoven fabric sheet was 120 N/50 mm width.

The procedure disclosed in Example 1(2) was repeated to form a unidirectionally orientated bulky nonwoven fabric sheet (area density=700 g/m²; thickness=20 mm; apparent density =0.035 g/cm³).

Further, the procedure disclosed in Example 1(3) was repeated for integrating the nonwoven fabric sheets, treating with needle-punching, fusing the fusible components, and expressing crimps, to obtain a nonwoven fabrics-laminate (area density=940 g/m²; thickness=20 mm).

Evaluation of Rigidity

Each of the nonwoven fabrics-laminates prepared in Examples 1 to 3 and Comparative Examples 1 and 2 was heated at 240° C. for 3 minutes, adjusted to a thickness of 15 mm using a cold press molding machine, and then cut to form a rectangular sample (length=300 mm; width=50 mm). An edge part (i.e., 70 mm from the end) of the resulting rectangular sample was fixed on a rectangular parallelepiped-shaped stand so that the remaining part (230 mm from the other end) thereof protruded from the stand edge into air. The whole was allowed to stand in a thermostatic chamber for 4 hours at 90° C. Then, a distance (unit=mm) that the non-fixed end (i.e., the free end) of the protruded part of the sample had fallen vertically from the starting point was measured.

The results are shown in Table 1. As apparent from Table 1, the nonwoven fabrics-laminate of the present invention exhibited rigidity at such a high temperature. Further, Table 1 shows that the nonwoven fabrics-laminate exhibited a superior rigidity when the average tensile strength of the entanglement-based nonwoven fabric was 150 N/50 mm width or more. Furthermore, it was found that the nonwoven fabrics-laminate of the present invention exhibits the required rigidity at a high temperature, and can be used as a starting material for an automotive internal trim panel which may be sometimes exposed to a high temperature, for example, in midsummer.

TABLE 1

| | Average | Falling |
|---|---|---|
| | tensile strength | distance |
| | (N/50 mm width) | (mm) |
| Example 1 | 180 | 15 |
| Example 2 | 220 | 13 |
| Example 3 | 260 | 10 |
| Comparative Example 1 | 100 | 25 |
| Comparative Example 2 | 120 | 22 |

Experiments for Evaluation of Properties
(1) Preparation of a Sample 1 of a Nonwoven Fabrics-laminate

The procedure disclosed in Example 1 was repeated, except that a compressed-entangled nonwoven fabric sheet (area density=120 g/m²; thickness=0.94 mm; apparent density=0.13 g/cm³; average tensile strength=234 N/50 mm width) prepared by passing the merely-entangled nonwoven fabric sheet obtained in Example 2 through a calendar at an ordinary temperature under an area pressure of 0.98 MPa, was used as the rigid layer, to obtain a Sample 1 (area density=940 g/m²; thickness=20 mm) of a nonwoven fabrics-laminate.

(2) Preparation of a Sample 2 of a Nonwoven Fabrics-laminate

The procedure disclosed in Example 1 was repeated, except that a compressed-entangled nonwoven fabric sheet (area density=120 g/m²; thickness=0.61 mm; apparent density=0.20 g/cm³; average tensile strength=256 N/50 mm width) prepared by passing the merely-entangled nonwoven fabric sheet obtained in Example 2 through a calendar at 100° C. under an area pressure of 0.98 MPa, was used as the rigid layer, to obtain a Sample 2 (area density=940 g/m²; thickness=20 mm) of a nonwoven fabrics-laminate.

(3) Preparation of a Sample 3 of a Nonwoven Fabrics-laminate

The procedure disclosed in Example 1 was repeated, except that a semifused-entangled nonwoven fabric sheet (area density=120 g/m²; thickness=0.42 mm; apparent density=0.29 g/cm³; average tensile strength=264 N/50 mm width) prepared by passing the merely-entangled nonwoven fabric sheet obtained in Example 2 through a calendar at 150° C. under an area pressure of 0.98 MPa, was used as the rigid layer, to obtain a Sample 3 (area density=940 g/m²; thickness=20 mm) of a nonwoven fabrics-laminate.

(4) Preparation of a Sample 4 of a Nonwoven Fabrics-laminate

The procedure disclosed in Example 1 was repeated, except that a fused-entangled nonwoven fabric sheet (area density=120 g/m²; thickness=0.41 mm; apparent density=0.29 g/cm³; average tensile strength=407 N/50 mm width) prepared by passing the merely-entangled nonwoven fabric sheet obtained in Example 2 through a calendar at 180° C. under an area pressure of 0.98 MPa, was used as the rigid layer, to obtain a Sample 4 (area density=940 g/m²; thickness=20 mm) of a nonwoven fabrics-laminate.

(5) Shapability

Each of the Samples 1 to 4 was cut to form a rectangular Sample (length=30 mm; width=50 mm). The rectangular Sample was heated by a circulation dryer at 240° C. for 3 minutes to fuse the sheath components in the heat-fusible sheath-core type polyester-based fibers, and adjusted to a thickness of 15 mm using a cold press molding machine.

In the Samples 2 to 4, buckling was observed between the rigid layer and the bulky layer. This means that, in the Samples 2 to 4, the rigid layer and the bulky layer were partially fused, and the shapability was poor.

To the contrary, no buckling was observed between the rigid layer and the bulky layer in the Sample 1. This means that the Sample 1 provides a good shapability. Further, no buckling was observed between the rigid layer and the bulky layer in the nonwoven fabrics-laminates prepared in Examples 1 to 3 and Comparative Examples 1 and 2. Therefore, it was found that a difference between the apparent density of the rigid layer and the apparent density of the bulky layer is preferably 0.14 g/cm³ or less.

(6) Falling Distance

The falling distances of the Samples 1 to 4 were measured according to the procedure disclosed in Evaluation of Rigidity and are listed in Table 2. The experiment of the evaluation of the rigidity revealed that a preferable thickness of the rigid layer is 0.8 mm or more, and a preferable apparent density of the rigid layer is less than 0.15 g/cm³.

(7) Maximum Load at a Point (Bending Test)

Each of the Samples 1 to 4 was heated at 240° C. for 3 minutes and pressed by a cold press molding machine to adjust the thickness to 15 mm. The pressed nonwoven fabrics-laminate was cut to form a rectangular Sample (length=150 mm; width=25 mm). The Sample was mounted as a bridge on two supporting stands which were separated and placed at 100 mm intervals. The center point between the stands (i.e., a midpoint 50 mm from both stands) was pressed downwards by a pressing wedge at 20 mm/min. The bending conditions were monitored by a tensile tester (TENSILON UCT-500; ORIENTEC, Co.), and a load having a maximum value (maximum load at a point) was measured and recorded. The results are shown in Table 2.

TABLE 2

| | | Maximum load |
|---|---|---|
| Sample of nonwoven | Falling distance | at a point |
| fabrics-laminate | (mm) | (N/25 mm width) |
| 1 | 13.5 | 5.6 |
| 2 | 16.0 | 4.9 |
| 3 | 18.5 | 4.4 |
| 4 | 18.7 | 3.9 |

As described, in the nonwoven fabrics-laminate of the present invention, the rigidity is provided by the rigid layer composed of the merely-entangled nonwoven fabric having a high average tensile strength or the entanglement-based nonwoven fabric prepared from the merely-entangled nonwoven fabric and having a higher average tensile strength, and the weight can be lightened by the bulky layer having an apparent density lower than that of the rigid layer. Therefore, the nonwoven fabrics-laminate of the present invention is not only rigid but also light. The automotive internal trim panel of the present invention is shaped from the rigid and light nonwoven fabrics-laminate and thus is not only rigid but also light.

Although the present invention has been described with reference to specific embodiments, various changes and modifications obvious to those skilled in the art are deemed to be within the spirit, scope, and concept of the invention.

1-18. (canceled)

19. A process for manufacturing a nonwoven fabric-laminate, comprising (A) a rigid layer of an entanglement-based nonwoven fabric, and (B) a bulky layer of a bulky nonwoven fabric having an apparent density lower than that of the rigid layer, comprising the steps of:
(a) preparing a merely-entangled nonwoven fabric by a fluid jet entangling method, the average of a longitudinal tensile strength thereof and a transverse tensile strength thereof being not less than 160 N/50 mm width;
(b) preparing the bulky layer; and subsequently
(c-1) subjecting the merely-entangled nonwoven fabric to a fusing treatment and/or an adhering treatment with a binder to convert the merely-entangled nonwoven fabric to the rigid layer of the entanglement-based nonwoven fabric, and then, laminating the rigid layer and the bulky layer; or
(c-2) laminating the merely-entangled nonwoven fabric and the bulky layer, and then, subjecting at least the merely-entangled nonwoven fabric to a fusing treatment and/or an adhering treatment with a binder to convert the merely-entangled nonwoven fabric to the rigid layer of the entanglement-based nonwoven fabric.

20. The process according to claim 19, wherein the area density of the merely-entangled nonwoven fabric is about 40 to 120 g/m².

21. The process according to claim 19, wherein the thickness of the rigid layer is 0.8 mm or more.

22. The process according to claim 19, wherein the apparent density of the rigid layer is less than 0.15 g/cm³, and an apparent density of the bulky layer is less than about 0.08 g/cm³.

23. The process according to claim 19, wherein the difference between the apparent density of the rigid layer and the apparent density of the bulky layer is not more than 0.14 g/cm³.
